(19) United States
(12) Patent Application Publication
(10) Pub. No.: US 2004/0197042 A1
(43) Pub. Date: Oct. 7, 2004

(54) Method and apparatus for alignment of a polarization maintaining optical fiber

(76) Inventor: Michael R. Matthews, Austin, TX (US)

Correspondence Address: 3M INNOVATIVE PROPERTIES COMPANY, PO BOX 33427, ST. PAUL, MN, 55133-3427, US

(21) Appl. No.: 10/406,927

(22) Filed: Apr. 4, 2003

(51) Int. Cl. G02B 6/27

(52) U.S. Cl. 385/11

(57) ABSTRACT

A device and method in accordance with the present invention align the polarization of an incoming light wave to the principal axis of a polarization maintaining (PM) optical fiber. Light is launched from the broadband source travels through a beam splitter to a polarizer, a polarization control device, a signal transmission medium and a birefringent medium having at least one partially reflective region including a cleaved and polished end face of the fiber or a Bragg grating written into a length of PM fiber. The reflected light is then used to align the polarization of the light to the birefringent axis of the PM fiber.

### FIELD

The present invention relates to aligning an optical fiber to a light source and more particularly, to aligning a polarization maintaining optical fiber to the polarization of a light source.

### BACKGROUND

In performing various measurements on polarization maintaining (PM) optical fibers and devices that use polarization-maintaining fibers it is desirable to align the polarization of the light launched into the fiber to the fiber's polarization axis. For example, in the measurement of a fiber Bragg grating, the spectral center wavelength of the grating's reflection band is dependent on which polarization is launched into the fiber. Furthermore, if a conventional spectrum analyzer is used, the polarization dependence of the spectrum analyzer response may cause measurement errors. Therefore one wishes to launch light into the fiber so that the polarization is aligned to the fiber axis. Fiber loop polarization controllers are often used to adjust the polarization of the light going into the fiber, but these measurement systems often require as much as fifteen minutes per measurement per fiber.

Conventional methods for measuring polarization in an optical fiber are composed of a light source that is used to launch light via free space through a polarizer before the light is coupled into a PM fiber. The light exiting the PM fiber is usually collimated into free space and goes through another polarizer prior to being measured by a detector or power meter. Alignment of the fiber within the light path is a major issue. Generally these measurement systems are not suitable for automated multiple fiber measurements because of the high accuracy needed in coupling the light from free space into the polarization maintaining fiber.

While the components within a given measurement system and the measurement protocol may vary, the free space launch of the light from a source through some auxiliary components and lenses is required before funneling the light into the polarization maintaining fiber. Some examples of measurement systems of this type are described in the European patent No. EP0190922, U.S. patent application publication No. 2002/0186913, and U.S. Pat. No. 4,673,244.

A second conventional method (for example, U.S. Pat. No. 5,245,400), polarized light is launched into the fiber aligned to the fiber's axis and the orientation of the output end of the fiber is determined by squeezing the fiber using a mechanical transducer. While this method may locate the fiber axis at any position along the length of the fiber, it requires a priori alignment of the light source to the fiber and therefore is unsuitable for aligning the light source itself. Also, the method relies on the ability to rotate the fiber. Therefore it is not well suited for the case in which it is desirable to hold the fiber fixed and rotate the polarization of the light source.

### SUMMARY

A desire remains for less difficult, less time consuming, and more accurate polarization alignment measurement techniques for use with polarization maintaining optical fiber. Additionally, the ability to measure multiple PM fiber assemblies is needed. Briefly, aspects of the invention include a method and apparatus for aligning at least one polarization maintaining optical fiber with a broadband light source. Light launched from the broadband source travels through a beam splitter to a polarizer, a polarization control device, a signal transmission medium and a birefringent medium having at least one partially reflective region. The reflective region may include the cleaved and polished end face of the fiber at the end that is not attached to the signal transmission medium, or a Bragg grating written into a length of PM fiber. Some of the light is reflected back through the signal transmission medium, the polarization control device, and the polarizer and into the beam splitter where the reflected light is redirected to a signal intensity detector. Monitoring the output of the detector and using the polarization control device may align the polarization to the birefringent axis of the PM fiber.

At least one aspect of the method of this invention will produce a linear output state of polarization from the PM fiber. Generally, it is difficult to engineer a linear output from fiber when the signal transmission medium is a single-mode fiber. This method allows such behavior.

One aspect of the invention is a method for setting the polarization of an incoming broadband source of light at a desired alignment with the polarization axis of a birefringent medium, the method comprising:

a) launching light from the source through a beam splitter having an input port, a transmission port, and a reflection port;

b) launching the transmitted light from the transmission port through a polarizer; through a polarization control device; then through a signal transmission medium and a birefringent medium; the birefringent medium having an at least partially reflective region that reflects a reflected light including at least a portion of the transmitted light after the transmitted light travels through at least a portion of the birefringent medium;

c) launching the reflected light through the signal transmission medium, the polarization control device and the polarizer, and into the transmission port of the beam splitter;

d) redirecting the reflected light onto a signal intensity detector; and

e) rotating the polarization of both the transmitted light and the reflected light using the polarization control device until the output of the detector reaches a desired value.

Another aspect of the present invention is an apparatus for setting the polarization of an incoming broadband source of electromagnetic radiation at a desired alignment with the polarization axis of a birefringent medium, the apparatus comprising:

a) a broadband source of radiation;

b) a beam splitter having an input port, a transmission port and a reflection port, the beam splitter coupled to receive a light from the broadband source;

c) a polarizer coupled to receive the light from the transmission port of the beam splitter;

d) a polarization control device coupled to receive the light from the polarizer;

e) a light transmission medium coupled to receive the light from the polarization control device;

wherein the birefringent medium is coupled to receive the light from the light transmission medium, the birefringent medium having an at least partially reflective region that reflects at least a portion of the light after the light travels through at least a portion of the birefringent medium;

wherein the reflected light is optically coupled to be launched through the light transmission medium, the polarization control device and the polarizer, and into the transmission port of the beam splitter;

f) a reflected light intensity detector coupled to the reflection port of the beam splitter;

g) a detector that monitors the intensity of the reflected light; and

h) a control device that rotates the polarization of both the original light and the reflected light using the polarization control device until the intensity the output of the detector reaches a desired value.

### BRIEF DESCRIPTION OF THE DRAWINGS

FIG. 1 is a schematic representation of a first exemplary embodiment of the present invention used to describe the basic theory behind the invention.

FIG. 2 is a plot of spectral intensity versus wavelength when the polarization is aligned with the fast/slow axis and when it is unaligned.

FIG. 3 is a schematic representation of a second exemplary embodiment of the present invention.

### DETAILED DESCRIPTION

The invention provides an improvement over current methods of aligning the polarization of light with the birefringent axis of a birefringent medium. The conventional processes may be difficult, time consuming, inaccurate, and do not always offer proper alignment of the polarization. In addition, most conventional methods for aligning the polarization of light to the birefringent axis of a birefringent medium require that the light pass completely through the birefringent medium prior to its detection. In contrast, the present invention requires only a single point of attachment to the apparatus. This is particularly useful if the birefringent medium is highly reflective.

A device in accordance with the present invention aligns the polarization of an incoming light wave to the principal axis of a polarization maintaining (PM) optical fiber. The PM fiber may contain a Bragg grating whose properties depend upon the polarization used for measurement. These properties may include grating central wavelength, bandwidth, and reflectivity.

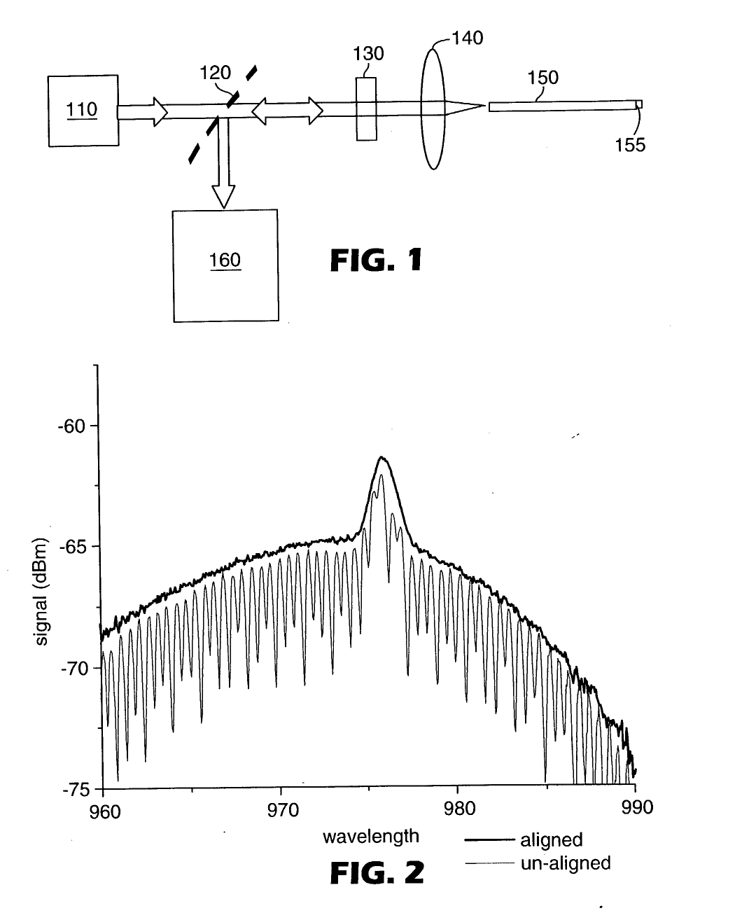

A first embodiment in accordance with the present invention is shown in FIG. 1, which shows a schematic of the system where the light travels through free space between the different components in the set-up. Light is emitted by an unpolarized, broadband light source 110. Alternatively, the source may be polarized, in which case additional optics may be used to create either circular or depolarized light. The light then travels through free space to a beam splitter 120. The transmitted light goes through a polarizer 130 and is coupled into a birefringent medium 150 with a coupling lens 140. After traveling some distance through the birefringent media 150, the light reflects off an interface 155 and retraces' its path to the splitter 120. A portion of the light reflects off the beam splitter 120 and travels to the photodiode 160 that transforms the light signal into an electronic signal. The system attempts to maximize the power at the photodiode by rotating the polarizer. If the birefringent medium has a birefringent axis other than linear, additional polarization control may be used.

The electronic signal I at the photodiode is the integral over the source spectrum S(λ), the photodiode response D(λ), and the light returned through the polarizer from the end of the PM fiber P(λ), and may be represented as;

I=∫S(λ)D(λ)P(λ)dλ Eq. 1

P(λ) is a matrix that combines the polarization rotation matrices from each of the elements of the system.

$$P ( λ ) = \vert ( \begin{matrix}1 & 0\end{matrix} ) {R ( θ )}^{T} {B ( k )}^{T} ( \begin{matrix}- 1 & 0 \\ 0 & 1\end{matrix} ) B ( k ) R ( θ ) {( \begin{matrix}1 \\ 0\end{matrix} )}^{2} \vert \\ W here \\ B ( k ) = ( \begin{matrix}exp ( - ⅈ {kn}_{1} L ) & 0 \\ 0 & exp ( ⅈ {kn}_{2} L )\end{matrix} ) \\ R ( θ ) = ( \begin{matrix}cos ( θ ) & sin ( θ ) \\ - sin ( θ ) & cos ( θ )\end{matrix} ) \qquad Eq . 2$$

For light traveling from right to left in FIG. 1, P(λ) is composed of the following terms for the light exiting the polarizer 130. R(θ) is an arbitrary rotation representing the relative angle between the polarizer and the birefringent axis of the birefringent medium 150. B(k) is the phase shift associated with the birefringent medium or PM fiber birefringence b=n₁−n2, which has a length, L. The remaining terms are the reflection matrix and the same path in reverse, ending with the polarizer 130.

Simplifying equation 2 gives the output power as a function of wavelength;

$$P ( λ ) = 1 - \frac{1}{4} ( 1 - cos ( 4 θ ) ) ( cos ( 4 π bL / λ ) + 1 ) \qquad Eq . 3$$

When θ=0,π/2 etc., this function is maximized for all λ, corresponding to alignment with either the fast or slow axis of the fiber. For all other θ, the power is either minimized or wavelength dependent. The photodiode integrates over this. Neglecting the diode response, the total output signal may be expressed as

$$I = {\int }_{- ∞}^{∞} P ( λ ) {I}_{0} σ \sqrt{π} exp ( - {( \frac{λ - {λ}_{0}}{σ} )}^{2} ) ⅆ λ \qquad Eq . 4$$

when the source has a Gaussian profile with total power I₀. This integral becomes

$$I = {I}_{0} - \frac{{I}_{0}}{4} ( 1 - cos ( 4 θ ) ) [ 1 + cos ( \frac{4 π b L}{{λ}_{0}} ) exp ( - {( \frac{2 π b L σ}{{λ}_{0}^{2}} )}^{2} ) ] . \qquad Eq . 5$$

Note that all information about the rotation and θ is lost if the exponential is approximately equal to one and the wavelength dependent cosine term is −1. This situation may occur if the source spectrum is too narrow for the given birefringence of the PM fiber. As a result, a minimum source spectrum is desired, such that the exponential term is small. Having the exponential term be less than one gives

bL×FWHM>0.4λ₀² Eq. 6

where b is the PM fiber birefringence, L is the PM fiber length, and FWHM is the full width at half max of the source spectrum. For common PM fibers, having a birefringence of 10⁻⁴ with L=1 meter of fiber, the source spectrum may be 3 nm wide at 980 nm and 8 nm wide at 1460 nm. Even if these criteria are not met, a reduction in sensitivity to θ is seen which does not introduce systematic alignment errors but only reduces the signal to noise ratio.

When the source spectrum is broad, the power level is

$$I = {I}_{0} - \frac{{I}_{0}}{4} ( 1 - cos ( 4 θ ) ) \qquad Eq . 7$$

and the goal of the feedback electronics is to maximize I, thus ensuring θ is aligned to one of the principle axes. FIG. 2 is a plot of output signal intensity, I, from equation 3 versus wavelength when the polarization is aligned with the fast or slow axis and when it is unaligned. The large-scale shape is due to the source spectrum, the peak near 976 nm is due to a grating in the PM fiber. The oscillations are clearly visible. It is also obvious that when the integral is performed over the spectrum, the power is less for the unaligned case. Indeed it is observed that the integrated power follows equation 7 such that the minimum is I=I₀/2. Note that the presence of the grating has a minimal effect on this system because its integrated power is a small fraction of the source spectrum.

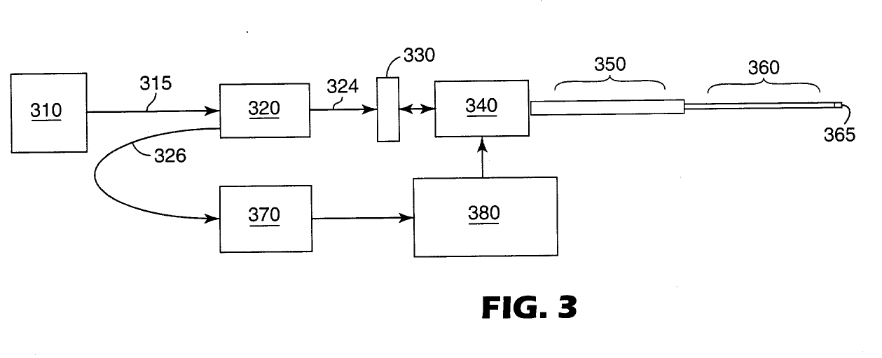

A second embodiment is provided for all fiber transmission as shown in FIG. 3. This system is not as accurate as the setup of FIG. 1, but is much more flexible and can be used with more devices. The apparatus for setting the polarization of an incoming broadband source of electromagnetic radiation at a desired alignment with the polarization axis of a birefringent medium comprises a broadband light source 310 and a beam splitter 320 having an input port 315, a transmission port 324 and a reflection port 326. The beam splitter is coupled to receive a light from the broadband source through the input port. A polarizer 330 that is coupled to receive the light from the transmission port 324 of the beam splitter 320 is connected to a polarization control device 340. The polarization control device is coupled to a light transmission medium 350, which is in turn coupled to the birefringent medium 360 wherein the transmission medium has an unknown polarization rotation and may be single mode optical fiber. The birefringent medium 360 having an at least one partially reflective region 365 that reflects at least a portion of the light after the light travels through at least a portion of the birefringent medium. The birefringent medium may be a PM fiber. The PM fiber includes a reflective cleave at a non-receiving end. Alternatively, the birefringent medium may be a PM fiber having a grating, in which case the center wavelength of the grating reflection or transmission needs to be monitored to determine the principal polarization state.

The reflected light is optically coupled to be launched back through the light transmission medium 350, the polarization control device 340, the polarizer 330, and into the transmission port 324 of the beam splitter 320. A reflected light intensity detector 370 is coupled to the reflection port 326 of the beam splitter 320. The detector 370 monitors the intensity of the reflected light and is coupled to a control device 380, wherein the control device includes a lock-in amplifier that outputs an electrical signal to control the polarization controller. The polarization controller rotates the polarization of both the original light and the reflected light using the polarization control device until the intensity of the output of the detector reaches a desired value.

The apparatus may also contain a frequency generator coupled to the polarization control device to induce in the light a periodic polarization modulation having a known frequency. And the control device may include a frequency demodulator that monitors the reflected light intensity at the known frequency.

The apparatus can align the polarization along a principal polarization state by having the control device monitor the detector output to maximize the intensity of the reflected light. However, if the desired alignment is at 45 degrees from a principal polarization state then the polarization control device monitors the detector output to minimize the intensity of the reflected light.

One method for setting the polarization of an incoming broadband source 310 of light at a desired alignment with the polarization axis of a birefringent medium 360 involves launching light from the broadband source 310 through a beam splitter or coupler 320 having an input port 315, a transmission port 324 and a reflection port 326 wherein the broadband source is a light emitting diode.

The light exits the coupler 320 from the transmission port 324 of the coupler 320 and is transmitted through a polarizer 330. The light passes through the polarizer and is transmitted through a polarization control device 340 that is capable of providing any polarization wherein the polarization control device may be a liquid crystal. (The polarization controller 340 may not be required for the idealized case as is the case when the birefringent medium 360 is linearly birefringent and the transmission medium 350 has zero birefringence.) The light is next transmitted through a signal transmission medium 350 wherein the transmission medium has an unknown polarization rotation and is a single mode optical fiber and finally through the birefringent medium 360 where the birefringent medium has an at least partially reflective region 365 that reflects a reflected light including at least a portion of the transmitted light after the transmitted light travels through at least a portion of the birefringent medium. The birefringent medium is a PM fiber having a reflective cleave at a non-receiving end or a grating within the birefringent medium.

The reflected light travels from the reflective region 365 back through the birefringent medium 360 and back through the signal transmission medium 350, the polarization control device 340 (if present) and the polarizer 330, and into the transmission port 324 of the coupler 320. The reflected light is redirected through the reflection port 326 onto a signal intensity detector 370.

The output of the detector 270 is monitored. The polarization of both the transmitted light and the reflected light may be altered using the polarization control device until the output of the detector reaches a desired value. The step of monitoring the output of the detector and rotating the polarization can include using control electronics.

Inducing a periodic polarization modulation having a known frequency on the transmitted and reflected light is done using the polarization control device. Monitoring the output of the detector may include monitoring reflected light intensity at the known frequency, wherein monitoring the reflected light intensity includes comparing the amplitude and phase of the modulated reflected light with an internal reference having the known frequency.

In the all-fiber case, one of ordinary skill in the art should be able to describe R(θ) that is analogous to Eq. 2 for the simple one-dimensional rotation. Not only should it be correctly expressed as a two dimensional rotation, but the angles may be functions of wavelength if the birefringence of the elements between the polarizer and the PM fiber is too high. The full rotation matrix consists of a two-dimensional rotation from the polarization controller and a two-dimensional rotation from the PM fiber between the controller and the PM fiber.

R(↓)→R_{fiber}(θ,φ)R_{cont}(α,β) Eq. 8

where R_{fiber}/R_{cont} is the rotation matrix of the fiber/polarization controller respectively.

In proper operation, these matrices are the inverse of one another so that the controller effectively pre-adjusts the polarization so that it enters the PM fiber correctly. The reciprocity of any elements between the polarizer and the PM fiber ensures that the returning light experiences the inverted rotation and all the light exits the polarizer when aligned.

Because the single-mode fiber and other components making up the path between the controller and the PM fiber will have arbitrary rotations, it requires that the polarization controller be able to access the entire polarization space. Liquid crystal rotators can be used because of their relative speed, simplicity and cost compared to other methods.

Small birefringence in the single mode fiber and the controller will impart a wavelength dependent polarization rotation. This will be noticeable if the source bandwidth is very large or the birefringence is high. If either of these are the case, the system will attempt to align based on the mean of the source's spectral distribution. Only at that wavelength will the polarization be aligned, with increasing misalignment as the wavelength departs from the center wavelength.

To estimate the amount of misalignment, it is assumed that the controller has been properly aligned for a specific wavelength λ₀. The relative angle of rotation for some other wavelength λ will be

$$Δ θ ( radians ) = π bL \frac{λ - {λ}_{0}}{{λλ}_{0}} \approx π bL \frac{Δλ}{{λ}^{2}} \qquad Eq . 9$$

for the most limiting case, when the birefringence b is oriented at 45 degrees with the incoming polarization. As an example, consider b=10⁻⁶ and L=5 meters. This means at 10 nm away from a 980 nm centered source, the angle error will be 9 degrees. These numbers for b and L exaggerate the effect of a real fiber; actual single mode fiber has a correlation length for birefringence, which depends on bends and stresses in the actual system. It is unlikely that the birefringent axis is continuous across the entire 5 meters, so in general one would expect a smaller Δθ. Clearly one wants to minimize the fiber length and birefringence.

In order to substantially improve the signal to noise and the speed of aligning to an axis, a lock-in technique may be used. A modulation of the polarization is applied to the polarization controller such that the two orthogonal rotations are modulated at different frequencies. Because there is only one measurement signal and two control signals, this must be done to insure independent operation of the orthogonal rotations. The feedback electronics may then independently minimize the error signal for each rotation element. That error signal has the form

V=V₀ sin(4θ) Eq. 10

where V₀ is related to the intensity falling on the intensity detector and the gain associated with the lock-in. By minimizing this function via feedback, the electronics effectively maximizes Eq. 7, thereby aligning on the axis. If one wishes to align such that the polarization has equal amplitudes along both axes of the birefringent media, then Eq. 10 is still used but the sign of the gain is set to minimize Eq. 7.

Given the multi-valued nature of Eq. 10, if it is desired to measure both the slow and fast axes, then the system must be somehow “kicked” to lock onto a neighboring minimum in the error signal. One method to accomplish this is to use a computer to output specific starting voltages before the feedback is enabled, in order to bias the locking of the system to a particular θ.

The light source is a broadband source such as an LED, a laser, super luminescent diode, etc as long as the bandwidth obeys equation 6. (For example an ILX lightwave broadband 980 or Thorlabs 1480 source available from Thor labs, Newton, N.J. may be used). Even strict observation of Eq. 6 is not required because lower bandwidths will reduce the signal to noise of the system but not introduce errors in the polarization alignment.

The coupler may be any device that splits light into a transmitted and reflected beam, such as a fused fiber coupler or free space beam splitter. An example of one device that may be used in this capacity is a 90/10 fused fiber coupler available from Gould, Middleville, Md.

The polarizer may be any device that substantially filters all light except for the desired polarization. Specifically, the filter may pass linear polarization with an extinction ratio of at least 100. Suitable polarizer and coupling optics are available from OFR Optics For Research, Caldwell, N.J. (fiber bench with FiberPort coupling optics, and linear polarizer).

The polarization controller has at least two polarization control elements, such that they may take the polarization exiting the polarizer and rotate it throughout all possible polarization states. It is preferred that the two elements provide orthogonal rotations, and are able to change at speeds of at least 10Hz. Possible implementations include liquid crystals, bulk waveplates, fiber squeezers, fiber rotators, or Mach-Zender type phase rotators such as lithium-niobate. Liquid crystals are available from Meadowlark Optics, Frederick, Colo.

The light transmission medium may be any medium, wherein the birefringence and length are small enough to provide the desired alignment accuracy over the desired bandwidth according to Eq. 9. It is preferred that the medium is a single mode optical fiber. It must have sufficiently low polarization dependent loss (<1 dB) in order not to incur systematic alignment errors. Other possible media include air and other waveguides such as polymer and multimode fibers. Additional coupling optics may be needed depending on the structure of the medium.

The birefringent medium is the medium under test, and may be any partially transmitting medium with birefringence of at least that required by Eq. 6. The birefringent medium may have a sufficiently low polarization dependent loss (<1 dB) in order not to incur systematic alignment errors. The medium should include at least a point of reflection or a distribution of reflections to provide the photodiode with ample power to achieve a good signal to noise ratio. The reflection at the end of the medium will be larger than about 0.1%. This reflection is significantly larger than any other reflections occurring between the coupler and this reflection point. It is preferred that the birefringent medium be a polarization maintaining optical fiber. Other possible media include air with an end mirror, polymer or other type of waveguide, or liquid. Additional coupling optics and/or a distinct reflection interface may be used with some media.

The photodiode may be any element that converts optical power into an electrical signal. It must have the bandwidth to accept the modulation frequency applied by the polarization control elements. For example, a photodiode with bandwidth greater than 100 Hz may be used and is available from New Focus, San Jose, Calif. (Model 2011 200 kHz photo-receiver).

The electronics may comprise simple analog feedback components, including modulation and demodulation and driving circuits for the polarization controller. A computer having sufficient analog input and output speeds may replace these analog components.

Many of the methods known in the art rely on the dependence of the phase shift on wavelength and polarization of the transmitted light as it travels through a PM fiber. In one common technique, the polarization rotates with a period known as the beat length as light travels down the fiber. Because this rotation rate is wavelength dependent, light exiting the fiber will have a polarization that is also wavelength dependent. This fact is commonly used to align the input polarization with the PM fiber axis; the input polarization is modified until the output is well polarized. In addition, such measurement systems frequently use an expensive device such as an Optical spectrum analyzer (OSA) or polarization analyzer to measure the signal of the output light.

One embodiment of the current invention obviates the need for these devices by using the light reflected from the end of a flat cleaved PM fiber. The reflected light travels back through the PM fiber accumulating additional phase shifts. It then passes through a polarizing filter. Only the total power exiting this polarizer is needed to align the input polarization with the PM fiber, greatly simplifying the setup and reducing the cost of this system. Additionally, the entire system may be fiber based, greatly simplifying the setup and eliminating the need for free space launching of the light and the problems associated with it.

The invention described herein bypasses the complexity and expense of the previous methods, at the cost of some accuracy. By utilizing a broadband light source, the cost is reduced over laser-based systems, but some depolarization may occur between the source and the PM fiber, resulting in a wavelength dependent alignment. However, for many applications this is not an issue. Further, the use of reflection back through the birefringent media increases the sensitivity by a factor of two, and requires only one polarization element.

It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

We claim:

1. A method for setting the polarization of an incoming broadband source of light at a desired alignment with the polarization axis of a birefringent medium, the method comprising:
a) launching light from the source through a beam splitter having an input port, a transmission port, and a reflection port;
b) launching the transmitted light from the transmission port through a polarizer; through a polarization control device; then through a signal transmission medium and a birefringent medium; the birefringent medium having an at least partially reflective region that reflects a reflected light including at least a portion of the transmitted light after the transmitted light travels through at least a portion of the birefringent medium;
c) launching the reflected light through the signal transmission medium, the polarization control device and the polarizer, and into the transmission port of the beam splitter;
d) redirecting the reflected light onto a signal intensity detector; and
e) rotating the polarization of both the transmitted light and the reflected light using the polarization control device until the output of the detector reaches a desired value.

2. The method of claim 1, wherein the birefringent medium is a polarization maintaining fiber.

3. The method of claim 2, wherein the polarizing maintaining fiber includes a reflective cleave at a non-receiving end.

4. The method of claim 1, wherein the transmission medium has an unknown polarization rotation.

5. The method of claim 4, wherein the transmission medium having an unknown polarization rotation is a single mode optical fiber.

6. The method of claim 1, wherein the polarization control device is a liquid crystal.

7. The method of claim 1, wherein the broadband source is a light emitting diode.

8. The method of claim 1, wherein the step of monitoring the output of the detector and rotating the polarization includes using control electronics.

9. The method of claim 1, further comprising
f) inducing a periodic polarization modulation having a known frequency on the transmitted and reflected light; and
g) monitoring the output of the detector including monitoring reflected light intensity at the known frequency.

10. The method of claim 9, wherein monitoring the reflected light intensity includes comparing the amplitude and phase of the modulated reflected light with an internal reference having the known frequency.

11. The method of claim 1, wherein the desired alignment is along a principal polarization state and the step of monitoring the detector output includes maximizing the intensity of the reflected light.

12. The method of claim 11, wherein the birefringent medium is a polarization maintaining fiber having a grating, further including the step of monitoring the center wavelength of the grating reflection or transmission to determine the principal state of the aligned axis.

13. The method of claim 1, wherein the desired alignment is at 45 degrees from a principal polarization state and the monitoring the detector output includes using the polarization control device to adjust the reflected light intensity to a minimum value.

14. An apparatus for setting the polarization of an incoming broadband source of electromagnetic radiation at a desired alignment with the polarization axis of a birefringent medium, the apparatus comprising:
a) a broadband source of radiation;
b) a beam splitter having an input port, a transmission port and a reflection port, the beam splitter coupled to receive a light from the broadband source;
c) a polarizer coupled to receive the light from the transmission port of the beam splitter;
d) a polarization control device coupled to receive the light from the polarizer;
e) a light transmission medium coupled to receive the light from the polarization control device;
wherein the birefringent medium is coupled to receive the light from the light transmission medium, the birefringent medium having an at least partially reflective region that reflects at least a portion of the light after the light travels through at least a portion of the birefringent medium;
wherein the reflected light is optically coupled to be launched through the light transmission medium, the polarization control device and the polarizer, and into the transmission port of the beam splitter;
f) a reflected light intensity detector coupled to the reflection port of the beam splitter;
g) a detector that monitors the intensity of the reflected light; and
h) a control device that rotates the polarization of both the original light and the reflected light using the polarization control device until the intensity the output of the detector reaches a desired value.

15. The method of claim 14, wherein the birefringent medium is a polarization maintaining optical fiber.

16. The method of claim 15, wherein the polarization maintaining optical fiber includes a reflective cleave at a non-receiving end.

17. The method of claim 14, wherein the transmission medium has an unknown polarization rotation.

18. The method of claim 14, wherein the medium of unknown polarization rotation is a single mode optical fiber.

19. The method of claim 14, wherein the polarization control device is a liquid crystal.

20. The method of claim 14, wherein the broadband source is a light emitting diode.

21. The method of claim 14, wherein the control device includes a lock-in amplifier, and an output electrical signal to control the polarization controller.

22. The method of claim 14, further comprising
a frequency generator coupled to the polarization control device to induce a periodic polarization modulation having a known frequency on the light; and
the control device including a frequency demodulator that monitors the reflected light intensity at the known frequency.

23. The method of claim 14, wherein the desired alignment is along a principal polarization state and the control device monitors the detector output to maximize the intensity of the reflected light.

24. The method of claim 23, wherein the birefringent medium is a polarization maintaining fiber having a grating, further including the step of monitoring the center wavelength of the grating reflection or transmission to determine the principal polarization state.

25. The method of claim 14, wherein the desired alignment is at 45 degrees from a principal polarization state and the control device monitors the detector output to minimize the intensity of the reflected light.
